(19) United States
(12) Patent Application Publication
(10) Pub. No.: US 2007/0001133 A1
(43) Pub. Date: Jan. 4, 2007

(54) Transport assembly for an opto-electro-mechanical scanning assembly for photostimulable phosphor imaging plates

(76) Inventor: Edgar Alzner, Garden City, NY (US)

Correspondence Address: CLIFFORD G. FRAYNE, Suite 7A, 136 Drum Point Road, Brick, NJ, 08723, US

(21) Appl. No.: 11/455,987

(22) Filed: Jun. 21, 2006

Related U.S. Application Data
(60) Provisional application No. 60/693,020, filed on Jun. 23, 2005.

(51) Int. Cl. G03B 42/08

(52) U.S. Cl. 250/589

(57) ABSTRACT

There is disclosed an improved transport assembly for an apparatus for interrogating or scanning an imaged storage substrate wherein a laser beam is directed towards the imaged storage substrate and wherein said transport assembly includes a drive roller member and an idler roller member and the drive roller member is form with races of teeth members which cooperate with grooves formed in an inner surface a transport belt member coursed about the drive and idler roller members.

### RELATED APPLICATION

Applicant claims the benefit of provisional application 60/693,020, filed Jun. 23, 2005.

### BACKGROUND OF THE INVENTION

1. Field of the Invention

This invention relates radiographic imaging, and more particularly to a transport assembly for an opto-electro-mechanical scanning assembly for retrieving information from imaged photostimulable phosphor imaging plates.

2. Description of the Prior Art

Traditional x-ray imaging systems using silver based films are being replaced by radiographic imaging systems using photostimulable phosphor imaging films or storage substrates thereby eliminating the need for physical storage of the imaged film since digital retrieval of the image information includes input and computer storage permitting viewing of such information on a CRT tube assembly or the equivalent thereof. Additionally, such computer storage imaging information permits facile electronic transmission to any predetermined location obviating the physical transfer of imaged film. Such radiographic imaging further permits the erasure of the image from the photostimulable phosphor imaging film or storage substrate and thus the subsequent reuse thereof.

In U.S. Pat. No. 5,874,744 to Goodman, et al., assigned to the same assignee as the present invention, herein incorporated by reference, there is disclosed a process and apparatus for processing radiographic information from an anisotropic storage phosphor screen including an opto-electro-mechanical assembly to achieve raster scan of an interrogating beam and including detector and computer assembly.

In U.S. Pat. No. 6,599,004 to Thoms, there is disclosed an apparatus for reading flexible storage films wherein the flexible storage film having image-wise projected information is positioned on a cylindrically-shaped surface and is caused to be linearly moved there over by transport assemblies while being interrogated or scanned via a slot by a light beam generated in a helical line in a continuous manner from a point disposed at the axis of the cylindrically-shaped surface.

In copending applications, Ser. Nos. 60/725,984 and 11/019,078 assigned to the same assignee as the present invention, hereby incorporated by reference, there is disclosed a similar apparatus in a vertical orientation for interrogating or scanning an imaged photo-stimulable phosphor substrate or storage substrate.

If the output signal of the photomultiplier is recorded together with the output signals of the position encoders, there is obtained an electric image of the x-ray image previously formed in the storage film in the form of exited metastable color centers of the phosphor particles. Such image is then further processed electrically in view of changing the scale of reproduction, emphasizing details, improving the signal/noise ratio, etc. The resulting x-ray image may be put into an archive in its original and/or digitally processed form requiring only little space.

In order to obtain a high degree of clarity and sharpness of the interrogated image, it is necessary that the transport assembly including belt and rollers assemblies transports the photostimulable phosphor imaging film or storage substrate at a preselect rate of speed such that the light source or laser beam interrogation and the detection of the fluorescent light output signal are synchronized with each other.

As more clearly illustrated in the Thoms reference, there are a plurality of radial positioned transport assemblies comprised of a drive roller and an idler roller having a belt coursed thereabouts which engage a pressure roller forming a nip therebetween for transporting the imaged storage plate.

The function of the fluorescent light output signal are synchronized. Generally, the drive roller is in frictional engagement with the belt and is subject to slippage after extended usage resulting in impaired results.

As used herein, the term “storage substrate” is a film plate or sheet including a photo-stimulable phosphor layer is capable of being imaged with ionizing radiation or x-rays which after imaging may be interrogated or scanned with a source of light energy to produce photostimulated luminescence information capable of being digit recovered and stored.

### OBJECTS OF THE INVENTION

An object of the present invention is to provide for an improved transport assembly for the transport of photostimulable phosphor imaging plate or storage plate within an optical scanner assembly.

Another object of the present invention is to provide an improved transport assembly providing more positive engagement between a drive roller and belt for transport of photostimulable phosphor imaging plate or storage plages within an optical scanner assembly.

A still further object of the present invention is to provide an improved transport assembly providing positive engagement between the drive roller and belt for transport of photostimulable phosphor imaging plate or storage substrate within an optical scanner assembly to provide more effective scanning of imaged storage plates.

Yet another object of the present invention is to provide an improved transport assembly providing positive engagement between the drive roller and belt for transport of photostimulable phosphor imaging plate or storage substrate within an optical scanner assembly to provide greater clarity of scanned information over extended periods of use.

### SUMMARY OF THE INVENTION

These and other objects of the present invention are achieved by an improved transport assembly including a drive roller having toothed race portion in cooperation with a belt member having a cooperating groove race for an optical scanning assembly for transport of imaged storage plates therethrough.

### BRIEF DESCRIPTION OF THE DRAWINGS

These and other objects of the present invention will become more readily apparent, particularly when taken in light with the accompanying drawings wherein:

FIG. 1 is an elevational view of the transport assembly of the present invention.

FIG. 2 is a cross-sectional view of the transport assembly of FIG. 1 taken along the lines II-II of FIG. 2 is an end view of a drive roller of the present invention;

FIG. 3 is an elevational view of the drive roller member of the transport assembly of the present invention;

FIG. 4 is a side view of the drive roller member of Figure;

FIG. 5 is a cross-sectional view of the belt member of the transport assembly of the present invention taken along the lines VI-VI of FIG. 6; and

FIG. 6 is a cross-sectional view of the belt member of FIG. 5 taken along the lines V-V of FIG. 5

### DETAILED DESCRIPTION OF THE INVENTION

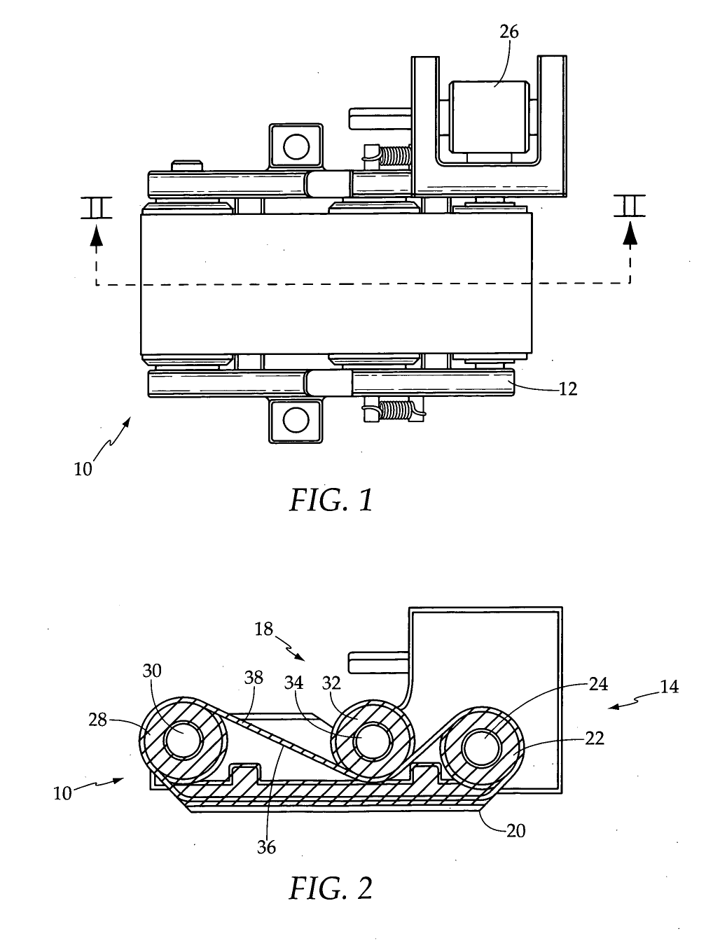

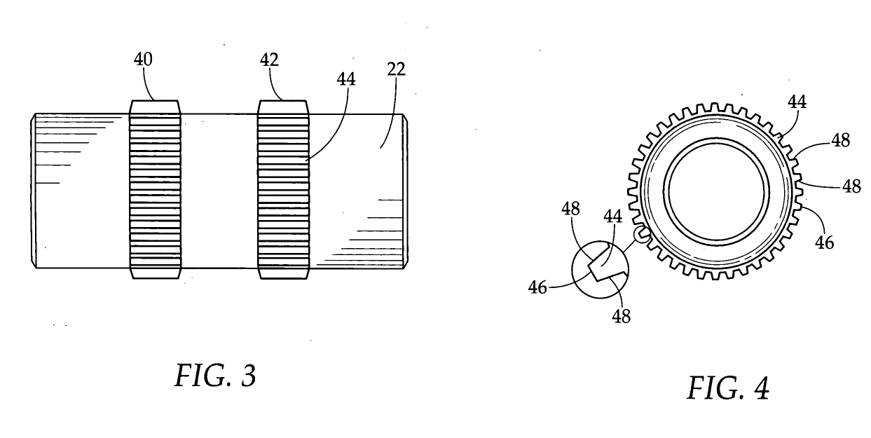

Referring now to the drawings, and particularly FIGS. 1 and 2, there is illustrated a transport assembly, generally indicated as 10, comprised of a frame 12 supporting a drive roller assembly, an idler roller assembly and a tension roller assembly, generally indicated as 14, 16 and 18, respectively, and a transport belt member 20, as more fully hereinafter described. The drive roller assembly 14 is comprised of a drive roller member 22 fixedly mounted on a spindle member 24 in driving relationship to a motor 26.

The idler roller assembly 16 is comprised of an idler roller member 28 mounted for rotation on a spindle member 30. The tension roller assembly 18 is comprised of a tension roller member 32 mounted for rotation on a spindle member 34. The transport belt member 20 has an inner surface 36 and an outer surface 38 is coursed with the inner surface 36 thereof about the drive roller member 22 of the drive roller assembly 14 and the idler roller member 28 of the idler roller assembly 16. The tension roller 32 is positioned to contact the outer surface 38 of the belt member 20 at a constant pressure to ensure positive drive thereof by the drive roller member 22.

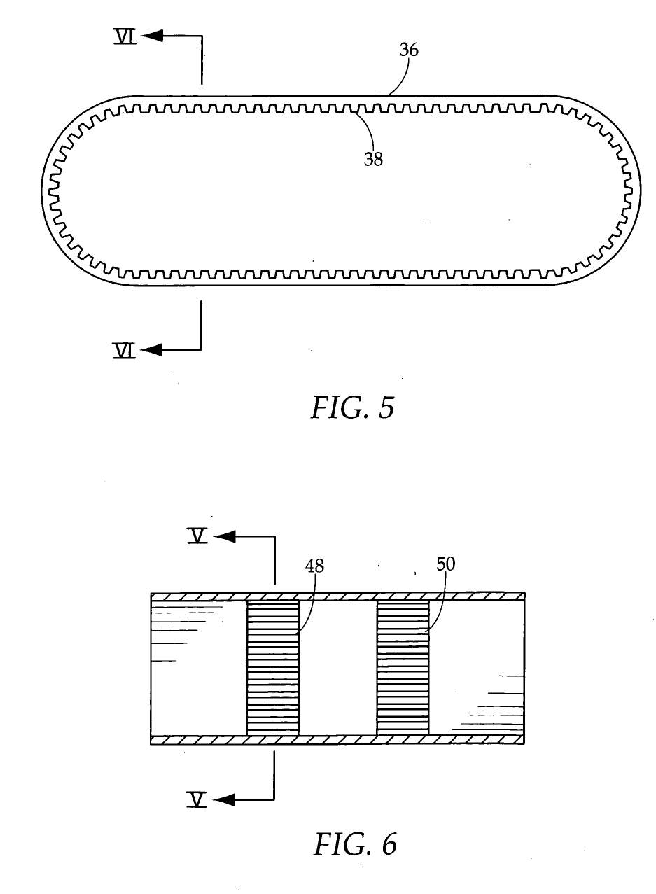

The drive roller member 22, referring now to FIGS. 4 and 5 is formed with parallelledly-formed and spaced apart gear races 40 and 42 comprised of teeth members 44 disposed on either sides of a center line of the drive roller member 22. Each teeth member 44 of a gear race is spaced-apart from adjacent teeth and is formed with a curvilinear end surface 46 and angled side walls 48.

The transport belt member 20, referring now to FIGS. 5 and 6, is formed with the outer surface portion 36 having sufficient tackiness to effectively engage a rear face of a photostimulable phosphor imaging plate or storage substrate in the transport thereof within the scanner assembly. The inner surface 38 of transport belt member 20 is formed with parallelledly rows of spaced-apart grooves 48 and 50 on either side of a center line thereof about the entire interior circumference of the transport belt member 20. Such rows of spaced-apart grooves 48 and 50 are complementary to the races 40 and 42 of the gear-like teeth members 44 on the drive roller 22 thereby to drive the transport belt member 20 as well as to align the transport belt member 20 on the drive and idler rollers 22 and 28 laterally or axially without the need for guide flanges.

In operation, each row 48 and 50 of the grooves in the inner surface 36 of transport belt member 20 are engaged by the races of two paralleledly disposed gear-like teeth members 44 formed on the circumference of the drive roller 22. In this manner, the transport belt member 20 is continuously and positively engaged by the drive roller during operation thereby insuring that the rotation of the transport belt member 20 is maintained at a constant speed and further providing more positive impetus to the transport belt member 20. Further, the inner surface 38 of the transport belt member 20 of the present invention can be perfectly smooth therefore eliminating any possibility of cogging around the small radius belt frame ends.

While the present invention has been described with respect to an exemplary embodiment thereof, it will be understood by one of ordinary skill in the art that many modifications or changes may be achieved without departing from the spirit and scope of the invention. Therefore, it is manifestly intended that the invention be limited only by the scope of the claims and the equivalence thereof.

What is claimed is:

1. In an apparatus for scanning an imaged storage substrate with a laser beam from a light source capable of producing photo-stimulable luminescent light from stored energy of the image which is detected, collected and stored in a computer assembly and wherein a transport assembly causes said imaged storage substrate to be passed over a cylindrically-formed slot, the improvement which comprises:
an improve transport assembly comprised of a drive and idler roller members and a belt member coursed thereabout wherein said drive roller is formed with gear means and an inner surface of said belt member is formed with groove means for cooperating with said gear means of said drive roller member to drive said belt member thereby to transport said imaged storage substrate over said slot.

2. The apparatus for scanning an imaged storage substrate as defined in claim 1 wherein said gear means of said drive roller are comprised of spaced apart races of teeth members disposed on either side of a center line of said drive roller member.

3. The apparatus for scanning an imaged storage substrate as defined in claim 2 wherein said said groove means in said transport belt member are comprised of space apart parallelledly-disposed grooves on either side of a center line of said transport belt member.

4. In an apparatus for scanning an imaged storage substrate as defined in claim 2 wherein said teeth members are formed with a curvilinear end surface and angled side walls.

5. The apparatus for scanning an imaged storage substrate as defined in claim 4 wherein outer surface of said transport belt member is formed with a tackiness material.

6. The apparatus for scanning an imaged storage substrate as defined in claim 2 and further including a tension roller member disposed in contacting relationship to an outer surface of said transport belt member.
